(19) United States
(12) Patent Application Publication
(10) Pub. No.: US 2015/0016668 A1
(43) Pub. Date: Jan. 15, 2015

(54) SETTLEMENT MAPPING SYSTEMS

(71) Applicant: UT-Battelle, LLC, Oak Ridge, TN (US)

(72) Inventors: Anil M. Cheriyadat, Oak Ridge, TN (US); Eddie A. Bright, Oak Ridge, TN (US); Varun Chandola, Oak Ridge, TN (US); Jordan B. Graesser, Oak Ridge, TN (US); Budhendra L. Bhaduri, Oak Ridge, TN (US)

(21) Appl. No.: 13/940,717

(22) Filed: Jul. 12, 2013

(51) Int. Cl. G06K 9/00

(52) U.S. Cl. CPC G06K 9/00637; G06K 9/00496
USPC 382/103

(57) ABSTRACT

A system detects settlements from images. A processor reads image data. The processor is programmed by processing only a portion of the image data designated a settlement by a user. The processor transforms the image data into a settlement classification or a non-settlement classification by discriminating pixels within the images based on the user's prior designation. The system alters the appearance of the images rendered by processor to differentiate settlements from non-settlements.

### STATEMENT REGARDING FEDERALLY SPONSORED RESEARCH AND DEVELOPMENT

The invention was made with United States government support under Contract No. DE-AC05-00IR22725 awarded by the United States Department of Energy. The United States government has certain rights in the invention.

### BACKGROUND

1. Technical Field

This disclosure relates to the analysis of settlements and more particularly to the extraction and characterization of settlement structures through high resolution imagery.

2. Related Art

Land use is subject to rapid change. Change may occur because of weather conditions, urbanization, and unplanned settlements that may include slums, shantytowns, barrios, etc. The variance found in land use may be caused by cultural changes, population changes, and changes in geography. In practice, the study and analysis of change use either aerial photos or topographic mapping. These tools are costly and time intensive and may not reflect the dynamic and continuous change that occurs as settlements develop.

The use of satellite imagery has not been effective in assessing certain settlement changes or identifying settlements quickly and inexpensively. For some satellite imagery, limited spatial resolution creates mixed pixel signatures making it unsuitable for detailed analysis. Roads, buildings and farmlands may not be entirely discernible due to the low spatial extensions that may blend some features of these objects with adjacent objects. Efficient scene recognition from image data is a challenge.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a graphical user interface displaying a high resolution image.

FIG. 2 is a graphical user interface displaying an automated detected settlement.

FIG. 3 is a graphical user interface displaying a second automated detected settlement.

FIG. 4 is a graphical user interface displaying a second high resolution image.

FIG. 5 is a graphical user interface displaying an automated detection of one settlement within FIG. 4.

FIG. 6 is a graphical user interface displaying an automated detection of two settlements within FIG. 4.

FIG. 7 is a graphical user interface showing user identified areas used in training a settlement mapping system.

FIG. 8 is a graphical user interface showing a fifth automated detected settlement areas using few training examples.

FIG. 9 is a settlement extraction process.

FIG. 10 shows exemplary multi-scale feature analysis.

FIG. 11 shows another exemplary multi-scale feature analysis.

FIG. 12 shows another exemplary multi-scale feature analysis applying filters and assigning labels.

FIG. 13 shows an exemplary discriminative random field model for classification.

FIGS. 14 and 15 show a graphical user interface in which a first class detection is trained and assigned to Settlement A.

FIGS. 16 and 17 show the graphical user interface in which a second class detection is trained and assigned to Settlement B.

FIG. 18 shows the graphical user interface that renders multiple features for analysis for FIGS. 14-17.

FIG. 19 shows the graphical user interface that enables the user to generate two level segmentations (Settlement A and Settlement B of FIGS. 14-17) in a new model labelled Beijing-level2 model.

FIG. 20 shows the bounded areas that the feature analysis highlighted in FIG. 18 used to generate the Beijing-level2 model.

FIGS. 21 and 22 show the detected settlements (Settlement A and Settlement B of FIGS. 14-17).

FIG. 23 shows that the visualization of the output of the settlement mapping system being rendered on Google Earth™.

### DETAILED DESCRIPTION OF THE PREFERRED EMBODIMENTS

This disclosure introduces technology that analyses high resolution bitmapped, satellite, and aerial images. It discloses a settlement mapping system (settlement mapping system/tool or SMTool) that automatically detects, maps, and characterizes land use. The system includes a settlement extraction engine and a settlement characterization engine. The settlement extraction engine identifies settlement regions from high resolution satellite and aerial images through a graphic element. The settlement characterization engine allows users to analyse and characterize settlement regions interactively and in real time through a graphical user interface. The system extracts features representing structural and textural patterns in real time. A real time operation may comprise an operation matching a human's perception of time or a virtual process that is processed at the same rate (or perceived to be at the same rate) or faster rate than the physical or an external process.

The extracted features are processed by the classification engine to identify settlement regions in a given image object that may be based on low-level image feature patterns. The classification engine may be built on a discriminative random field (DRF) framework. The settlement characterization engine may provide feature computation, image labelling, training data compilation, discriminative modelling and learning and software applications that characterize and color code settlement regions based on empirical data and/or statistical extraction algorithms. Some settlement mapping systems execute Support Vector Machines (SVM) and Multiview Classifier as choices for discriminative model generation. Some systems allow users to generate different file types including shape files and Keyhole Mark Language (KML) files. KML files may specify place marks, images, polygons, three-dimensional (3D) models, textual descriptions, etc., that identify settlement regions and classes. The settlement mapping system may export data and/or files that are visualized on a virtual globe, map, and/or geographical information such as Google Earth TM. The virtual globe may map earth and highlight settlements through the superimposition of images obtained from satellite images, aerial imagery, Geographic Information System 3D globes (GIS 3D), and KML and KML like files generated, discriminated, and highlighted by the settlement mapping system.

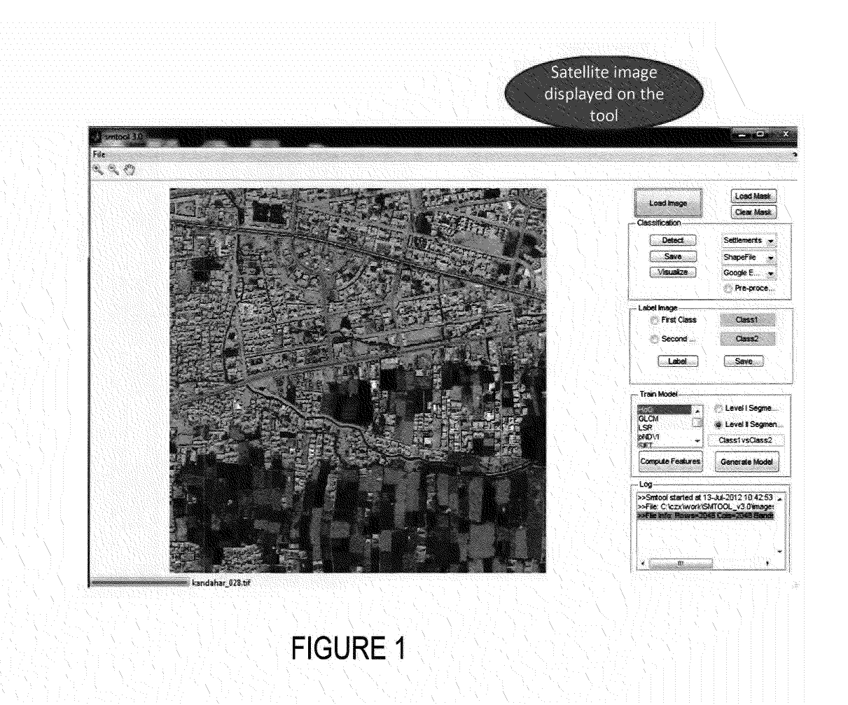

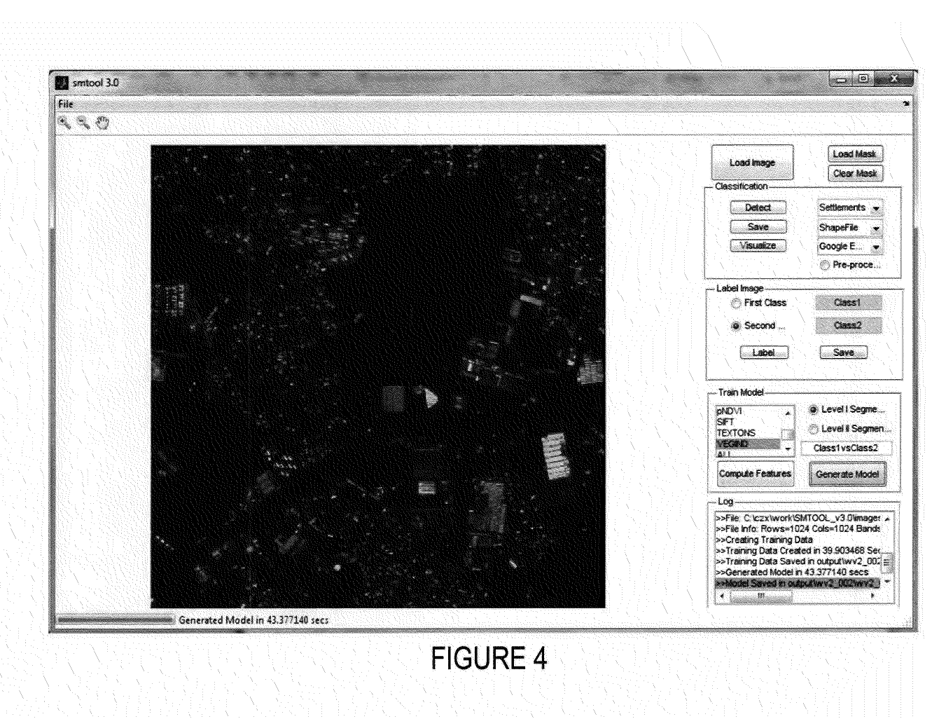

As shown in FIGS. 1 and 4 the settlement mapping system allows users to load images and display images in various sizes and file formats. The files may include Geocoded images that are automatically loaded when a load image graphic object (or element) is selected and activated. When loading large images, the settlement mapping system loads an entire image by reading and rendering blocks of image data. A log window rendered on the graphical user display records and displays the actions executed by the user and the settlement mapping system. The log window also provides relevant image information including image dimensions, number of bands, and the bit depth. The output file names and locations may also be displayed through the log window. In FIG. 1 the log window is rendered with a status bar (shown below the image) that appears near the bottom of the window, rendering a short text message on the current condition of the program and in some applications detection times. Zoom objects (shown as magnifiers) and a pan object (represented as a hand) are also rendered near the top of the window on the display. The zoom object allows a user to enlarge a selected portion of the image to fill the window on the screen. It may allow a user to detect, label or train enlarged portions of an image to render a finer or greater level of detail discrimination when identifying settlements. The pan object allows the user to move across the image parallel to the current view pane. In other words, the view rendered on the display moves perpendicular to the direction it is pointed with the direction not changing.

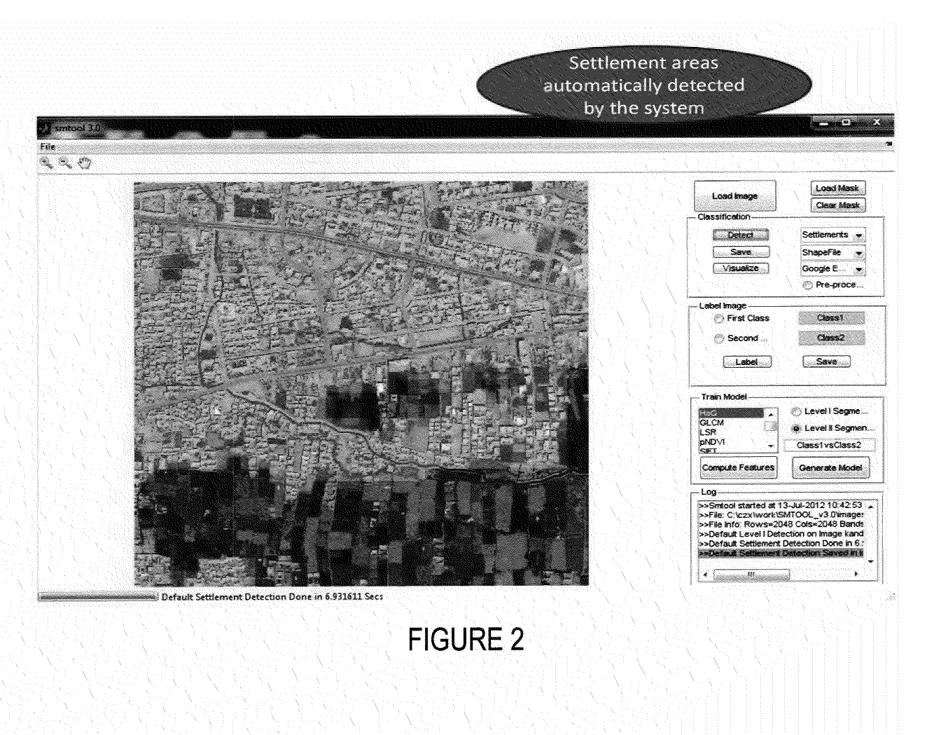

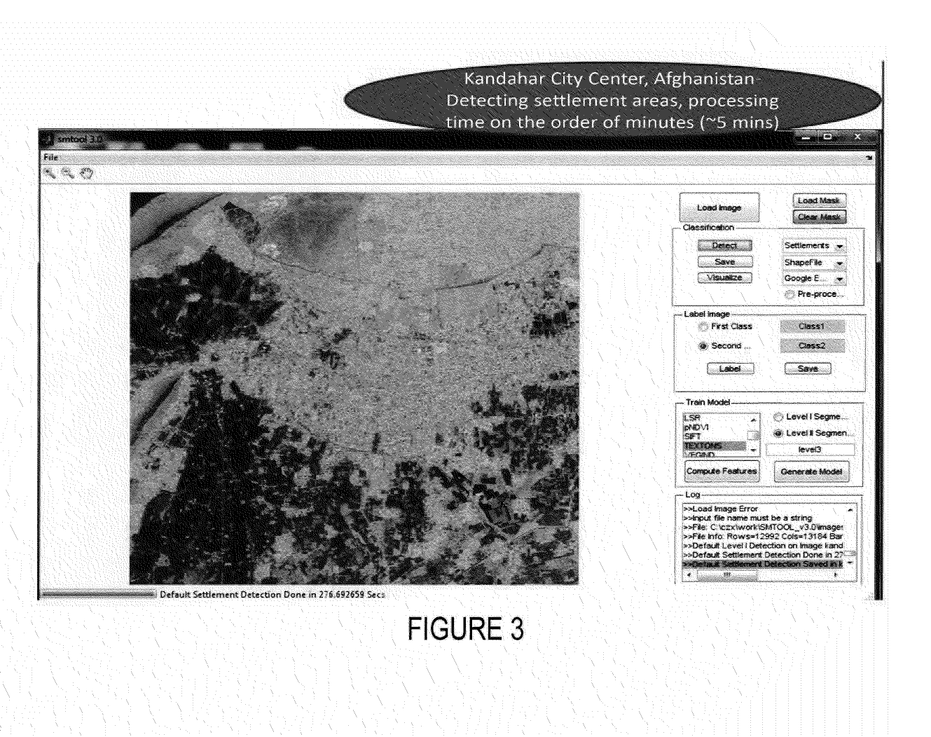

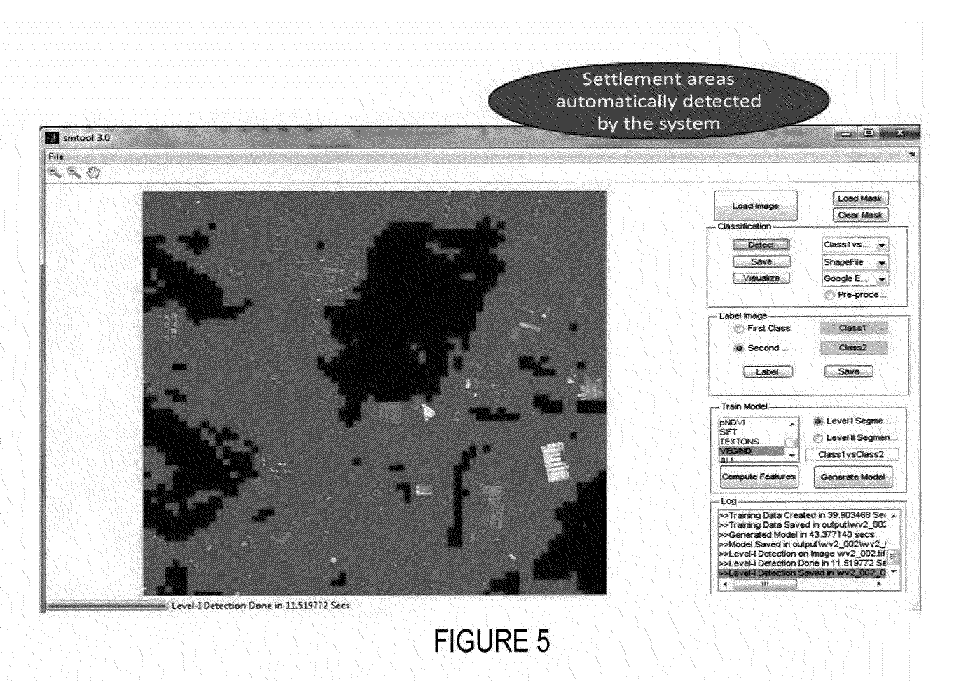

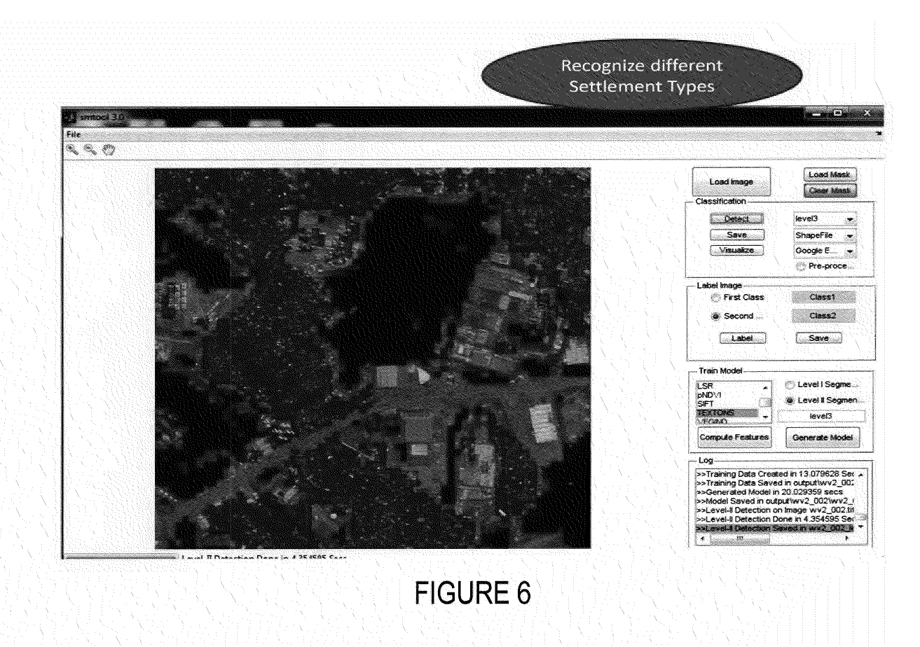

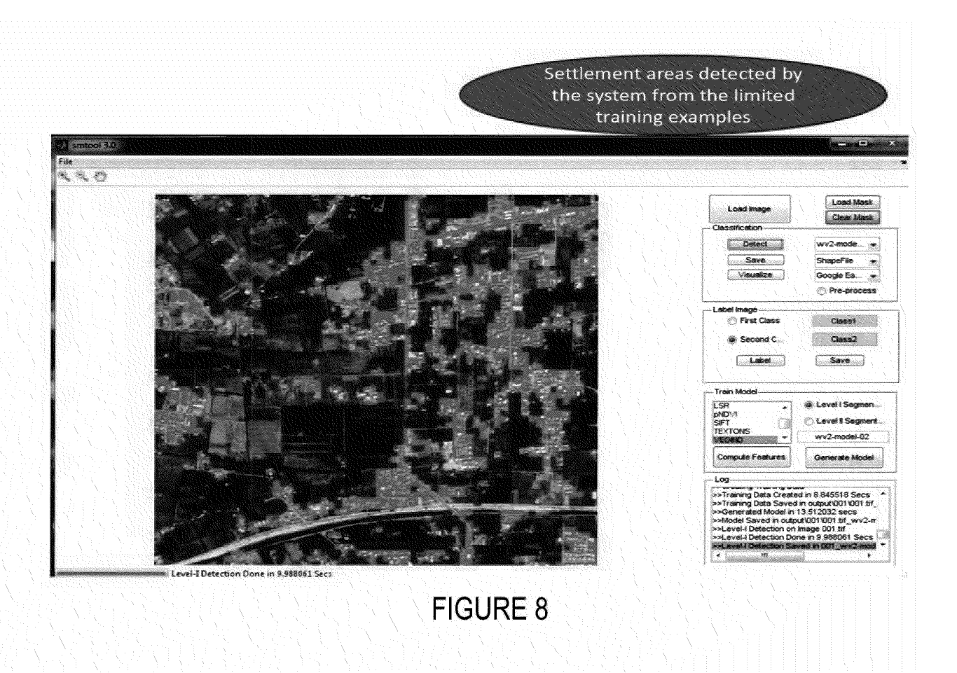

Activating the detect graphic object (or element) under the classification function activates the settlement extraction engine on the loaded image. The extraction engine may manage and execute programs and functions including those programmed and linked to text objects in the pull-down menu adjacent to the detect object. On a large image, the settlement extraction engine may operate in block mode. The spacing of the edges of a selected image object, the relationship of the edges of the image object to surrounding materials or other image objects, the co-occurrence distribution of the image, etc., for example, may allow the extraction engine to identify discrete settlement structures within images as shown in the detections highlighted in FIGS. 2, 3, 5, 6 and 8. Some systems may execute adaptive histogram equalization in pre-processing to enhance the image contrast on a loaded image. In the graphical user interfaces shown in FIGS. 1-8, a radio button object appearing as a small circle on the graphical user display may be selected to activate pre-processing through the settlement extraction engine.

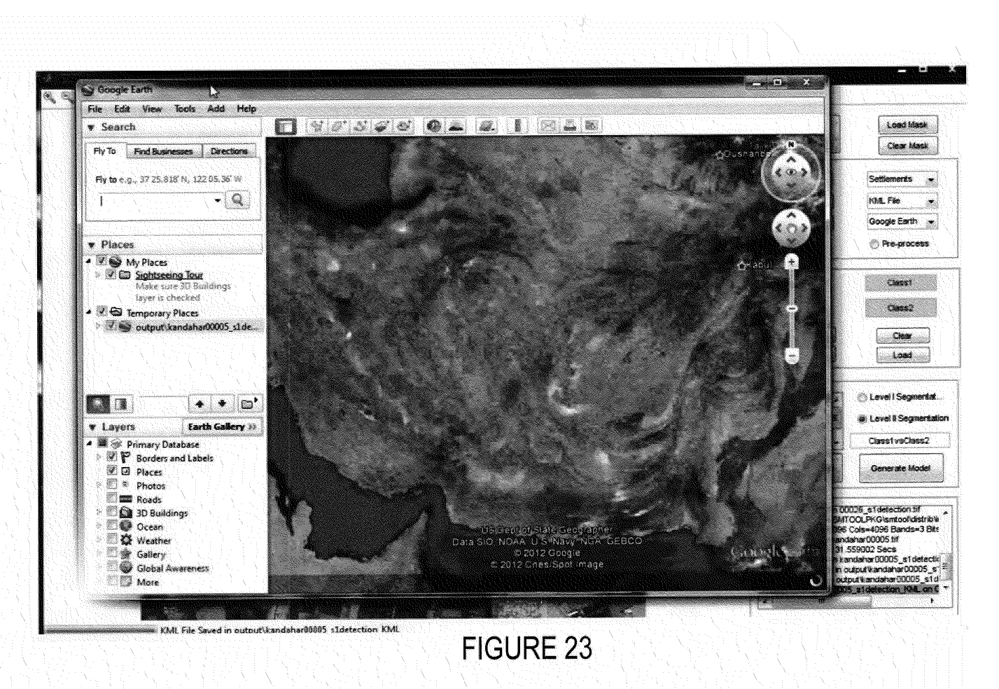

The settlement extraction output generated by the extraction engine may be saved in many file formats. To save a settlement extraction output as a vector format shape file for example as shown in FIG. 2, a user may choose the shape file format from the pull-down menu and activate the save graphic object (or element). To save settlement boundaries and other output in a KML file format, a user chooses the KML File format from the pull down menu and selects the save object that saves the image and automatically saves the features associated with the image that define the KML file format. As shown in FIG. 2, the log window and the status bar object display relevant file information on the output file names and locations. The output generated by the settlement mapping system can be visualized on a virtual globe, map, and/or geographical information such as Google Earth™ as shown in FIG. 23. The virtual globe maps earth through the superimposition of images obtained from satellite images, aerial imagery, and other systems that capture low or high resolution imagery.

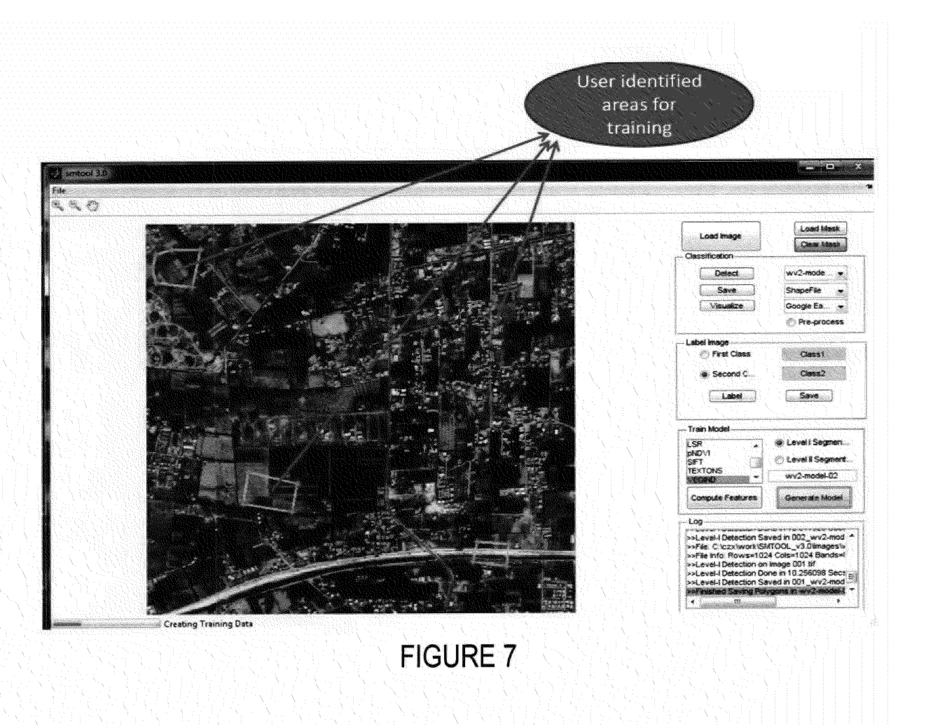

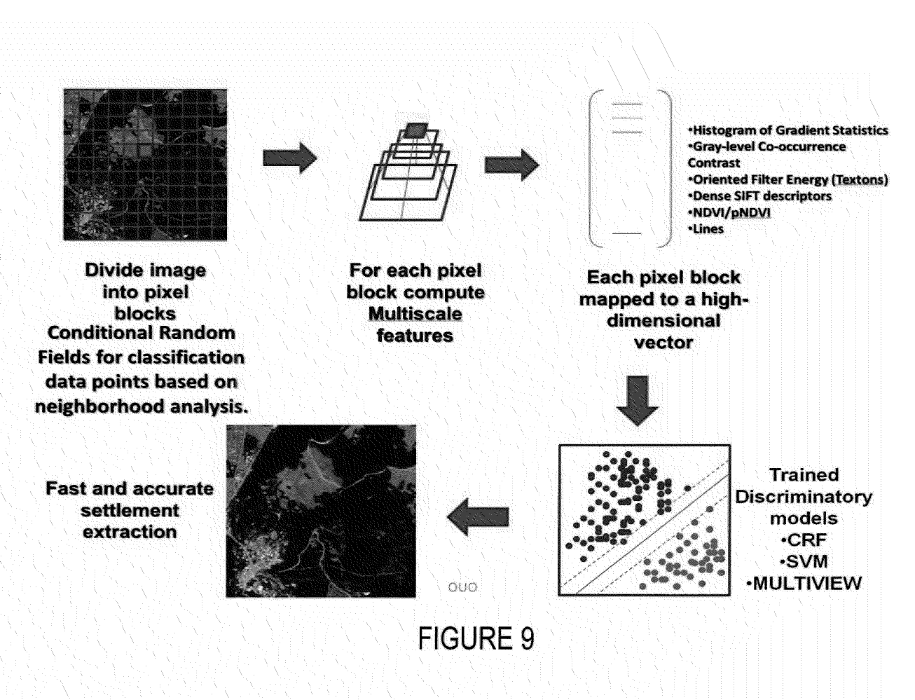

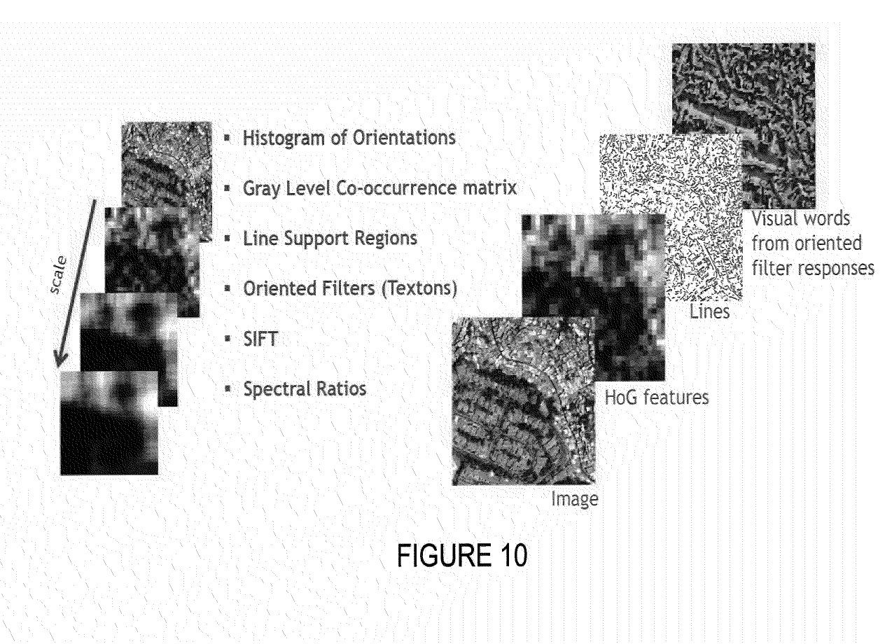

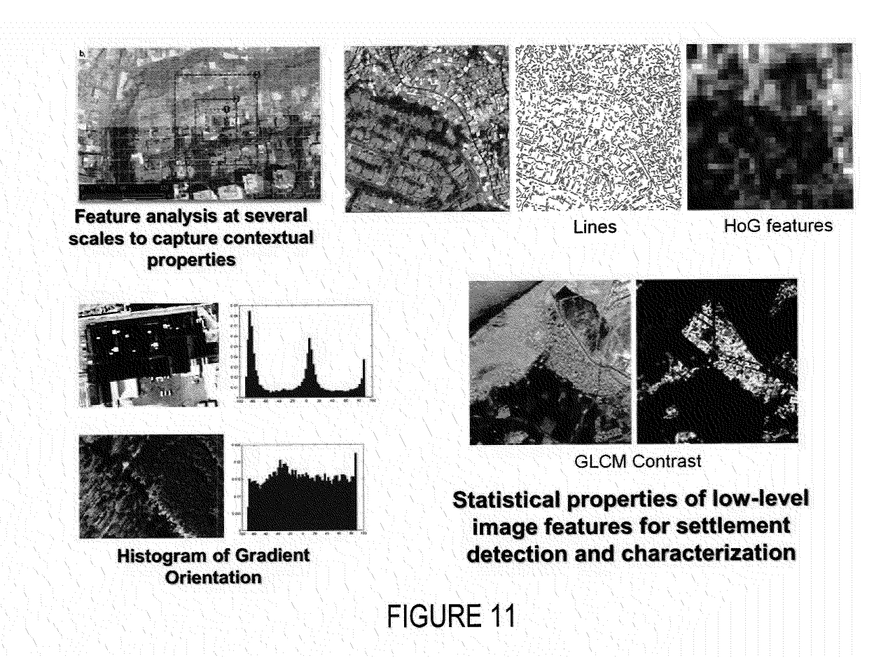

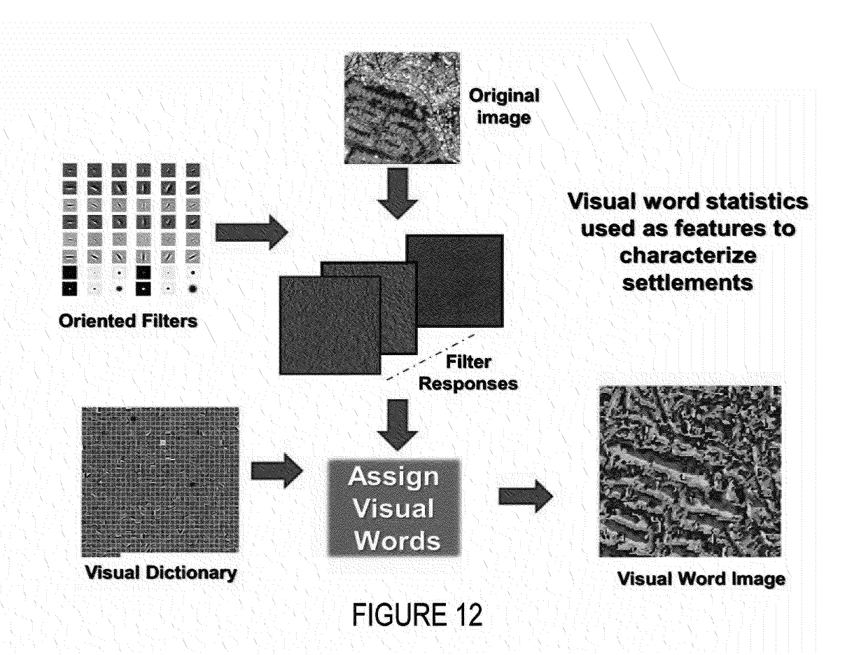

The settlement extraction system may execute one, two, or more multi-scale low-level feature analysis (or in alternative systems, and/or high level feature analysis) to generate the discriminatory models based on user defined image training data shown in FIG. 7. The settlement extraction engine divides high and/or low level images into pixel blocks as shown in FIG. 9. The blocks are coded as conditional random fields used for classification data points based on neighborhood analysis. For each pixel block settlement extraction system may calculate one, two, or more features concurrently or in a sequence as shown in FIGS. 9-12. The features may include a Histogram of Oriented Gradients (HoG), a Gray Level Co-occurrence Matrix (GLCM), Line Support Regions (LSR), Scale Invariant Feature Transform (SIFT), Textrons, spectral ratios, Pseudo NDVI (pNDVI), etc. The HoG captures the distribution of structure orientations by detecting and counting the occurrences of gradient orientation in localized portions of an image. The programming may be similar to that of edge orientation histograms, scale-invariant feature transform descriptors, and shape contexts, but differs in that it is computed on a dense grid of uniformly spaced pixels and uses overlapping local contrast normalization for improved accuracy. The HoG computes gradient magnitude and orientation at each pixel. A binary filter may be used for gradient calculations. At each block, the system computes the histogram of gradient orientations weighted by their gradient magnitudes by considering pixels that were contained within the window. In some applications, the system may process fifty bins or more that are apart by roughly five bins to compute the histogram of orientations. The system may apply kernel smoothing to the histogram to dampen the noise introduced by hard quantization of the orientations. From the smoothed histogram, the system may compute the mean (heaved central-shift moments corresponding to order 1 and 2) and orientation features. The orientation features are the location of the histogram peak and the absolute sine difference of the orientations corresponding to the two highest peaks. The system may process windows of many sizes including 50×50, 100×100, and 200×200 window sizes, for example to compute multi-scale features at each block. Thus, for a block b, the system may have a total of fifteen features capturing the orientation characteristics of the neighborhood.

The grey-level co-occurrence matrix (GLCM) takes into account the different directional components of the textural signal and is invariant to rotation and radiometric changes. The pixel-wise minimum of twelve displacement vectors using the contrast measure is computed by the system at many scales such as scales of 25×25, 50×50, and 100×100, for example. In addition to ten displacement vectors that may be processed, the settlement extraction system may also process (2,−2) displacement vectors, corresponding to the X and Y pixel shifts, respectively. These additions may account for the pixel block approach account for nearly every pixel within the given neighborhood. A PanTex index feature (or texture derived built-up index feature) may be generated that may be described as BuiltUp(bᵢ)=∩ᵢtxᵢ;i ∈[1 . . . n] where BuiltUp(bᵢ) is the PanTex feature at block bᵢ and n is the number of displacement vectors.

The Line Support Regions may provide intermediate representation of a neighborhood based on the local line parameters captures such as the size, shape, and spatial layout. The settlement extraction system may extract straight line segments from an image by grouping spatially contiguous pixels with consistent orientations. Following one or more straight line extractions, the system normalizes the image intensity range between about 0 and about 1, and computes the pixel gradients and orientations. The orientations may be quantized into a number of bins, such as eight bins for example, ranging from about 0 to about 360, in 45 degree intervals. To avoid line fragmentation attributed to the quantization of orientations, the system may quantize the orientation into more bins such as another eight bins starting from 22.5 to degrees to (360 degrees+22.5 degrees), at 45 degree intervals. Spatially contiguous pixels falling in the same orientation bin may form the line supporting regions. Regions may be generated separately based on the different quantization schemes and the results may be integrated by selecting line regions based on an automatic pixel voting scheme. One such voting scheme may ignore pixels with gradients below a predetermined threshold (about 0.5 for image intensity ranging between about 0 and about 1) to reduce noisy line regions. The system may compute the line centroid, length, and orientation from a Fourier series approximation of the line region boundary.

The Scale-Invariant Feature Transform (SIFT) may be used to characterize formal and informal settlements. The settlement extraction system may apply a dense SIFT extraction routine on each image to compute a vector such as a 128 dimensional feature vector for each pixel, for example. The system may randomly sample a fixed number of features, such as one-hundred thousand SIFT features for example from the imagery and apply clustering to generate a SIFT codebook. The SIFT codebook may consist of quantized SIFT feature vectors which are the cluster centers identified by the clustering. The cluster centers may be referred to as code words. In some implementation, the settlement extraction system employed K-means clustering with K=32. The SIFT feature computed at each pixel is assigned a codeword-id ([1 to K]) based on the proximity of the SIFT feature with the pre-computed code words. Some systems may execute Euclidean distance for the proximity measure. To compute the SIFT feature at block, settlement extraction system may render a 32-bin histogram at each scale by considering different windows around the block. The settlement extraction system may compute a number of SIFT features such ninety-six SIFT features (SIFT (bᵢ)) from three scales. For dense SIFT feature computation the system may apply the algorithms found in an open and portable library of computer vision algorithms available at http://www.vlfeat.org/2008.

The settlement extraction system may apply orientated feature energy (Textrons) or Textron frequencies at each pixel block to characterize different settlements based on its texture measures. The settlement extraction system may execute a set of oriented filters at each pixel. The system may use predetermined number of filters such as eight oriented even-symmetric and odd-symmetric Gaussian derivative filters (or total of about 16 filters) and a Difference-of Gaussians (DoG) filter. Thus, each pixel may be mapped to a 17-dimensional filter response. The system may execute K-means clustering on a random number of responses, such as one hundred thousand randomly sampled filter responses from the imagery. The resulting cluster centers may define the set of quantized filter response vectors called textons based on empirical data. The system assigns pixel in the imagery a texton-id, which is an integer between [1, K], based on the proximity of the filter response vector with the pre-computed textons. Similar to SIFT features, the system may execute Euclidean distance for the proximity measures and the pixel is assigned the texton-id of the texton with a minimal distance from the filter response vector. At each block, the settlement extraction system computes the local texton frequency by producing a K-bin texton histogram. The system may generate the K-bin texton histogram at three different scales with three different windows. For each block, by concatenating histograms produced at three different scales, the system may generate a ninety-six-dimensional texture feature vector (TEXTON (bᵢ)). The feature computation for each pixel block may result in a two hundred and thirty-dimensional feature vector.

f(bᵢ)={GLCM(bᵢ)³, HoG(bᵢ)¹⁵, LSR(bᵢ)⁹, LFD(bᵢ)⁶, Lac(bᵢ)³, rgNDVI(bᵢ)¹, rbNDVI(bᵢ)¹, SIFT(bᵢ)⁹⁶, TEXTON(bᵢ)⁹⁶},

i=1, 2, . . . , N

where N is the total pixel blocks, and the superscript on each feature denotes the feature length.

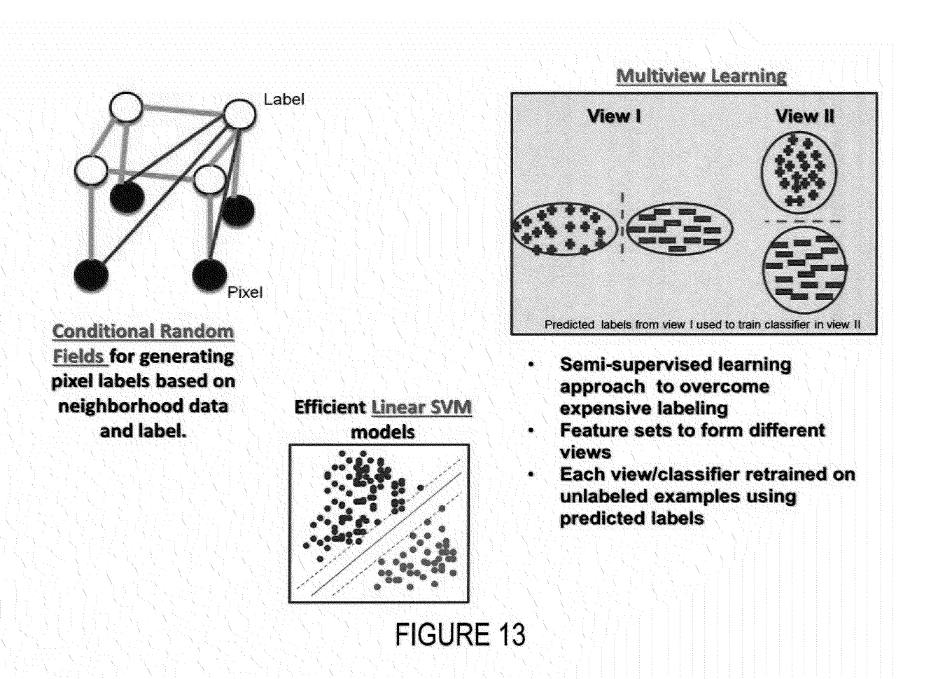

The settlement extraction system's classification engine may be built on a discriminative random field (DRF) framework. The DRF framework may classify image regions by incorporating neighborhood spatial interactions in the labels as well as the observed empirical data as shown in FIG. 13. The DRF framework derives its classification power by exploiting the probabilistic discriminative models instead of the generative models used for modeling observations in other frameworks. The interaction in labels in DRFs is based on pairwise discrimination of the observed data making it data-adaptive instead of being fixed a priori. The parameters in the DRF model may be estimated simultaneously from the training data and may model the posterior distribution that can be written as:

$$P ( y \vert x ) = \frac{1}{Z} \text{?}$$

$$\text{?} \text{indicates text missing or illegible when filed}$$

As explained in FIG. 13, the multi-view training executes feature sets to form different views. And, each viewer/classifier retained on unlabeled examples use predicted labels.

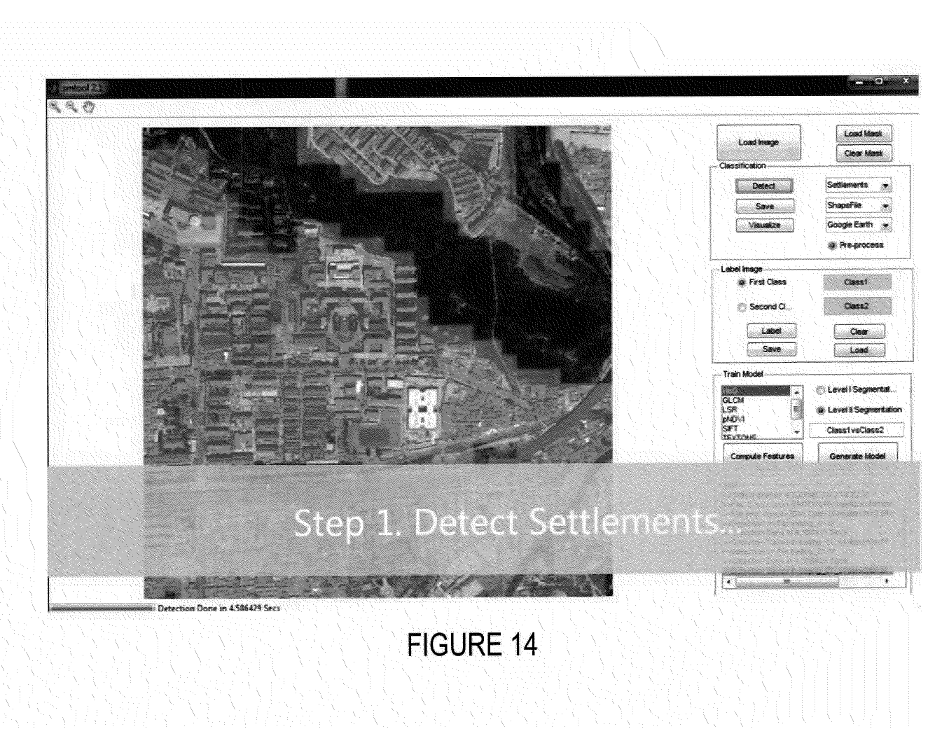

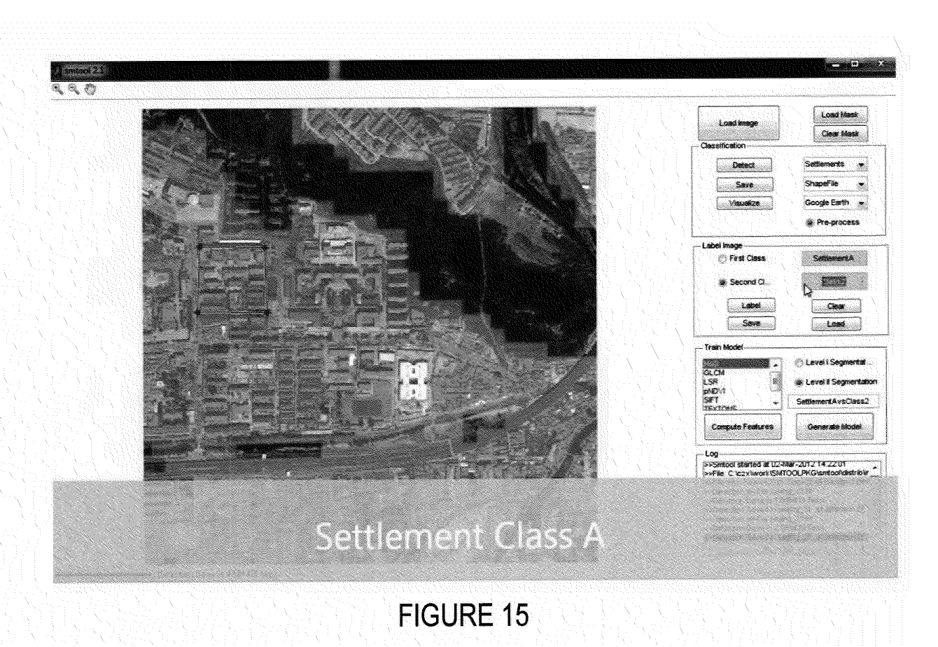

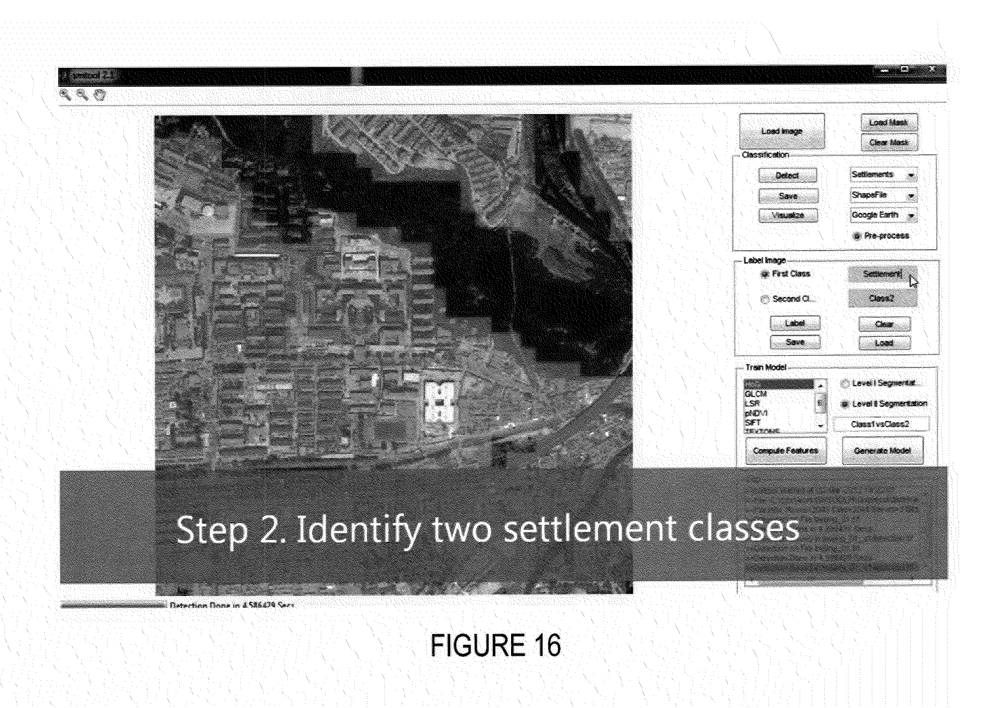

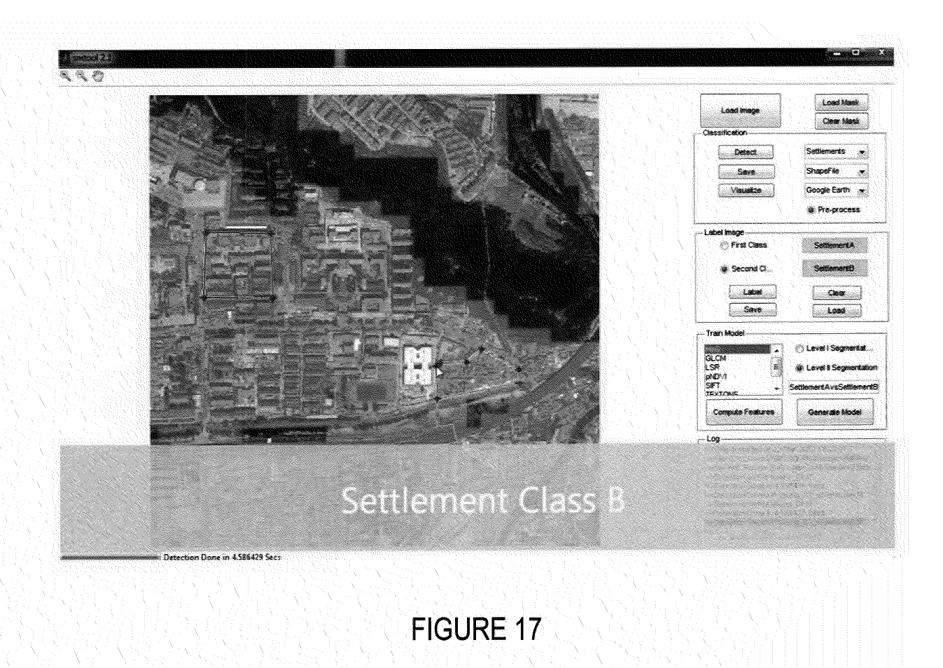

Once a settlement extraction is completed, the settlement characterization engine may execute multiple functions including (1) label image, (2) train data, (3) model generation and learning and, (4) detecting one, two, or more settlement classes using generated/learned models. The settlement extraction system allows user to label or associate portions of images with a certain settlement class. The labeled image portions are processed in a training data compilation. To generate the training data a user may label a portion of an image. A user first selects and labels a button or graphic object on the graphical user display and provides a class name, such as “Settlement A” as shown through FIGS. 14 and 15. Once the label object is assigned a name, its activation (the Settlement A button, under label image in FIG. 15) allows user to draw or superimpose or designate discrete boundaries or polygon boundaries on the image to associate the enclosed image patches (or portions) with a “Settlement A” label. Similarly, a user may select a second graphic object or element and provides a second class name such as “Settlement B” as shown in FIGS. 16 and 17 for example, when applying level two type segmentation. Activating the “Settlement B” object allows user to designate, draw or superimpose discrete boundaries or polygon-like boundaries on the image to associate image patches (bounded area) with the “Settlement B” label.

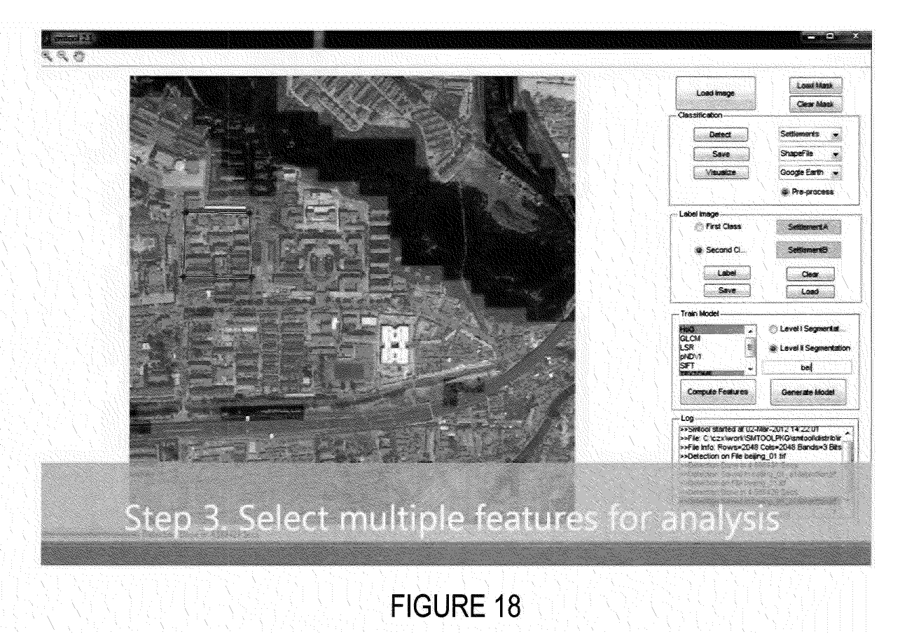

To compile the settlement extraction system's training data a user may select the feature sets that are needed for settlement characterization as shown in train model portion of the display shown in FIG. 18. The user may select two, three, (or more) or all of the features described herein such as the HoG and textron feature that may rendered and selected through a feature list via the display. To use unlabeled data, a user may select an unlabeled option. Selecting the unlabeled object may be required for multiview classification and semi supervised support vector machines.

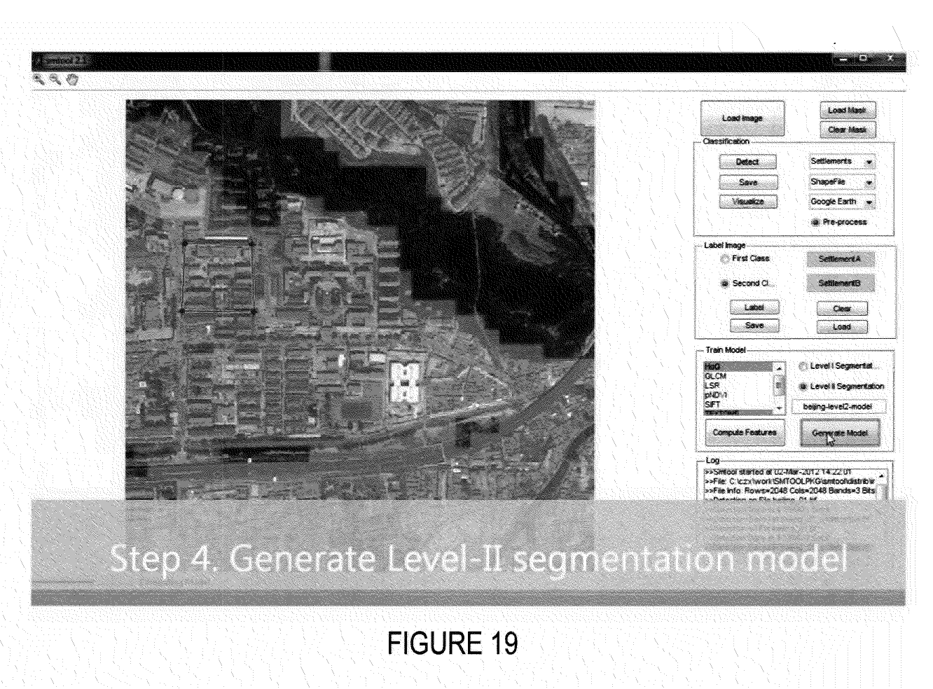

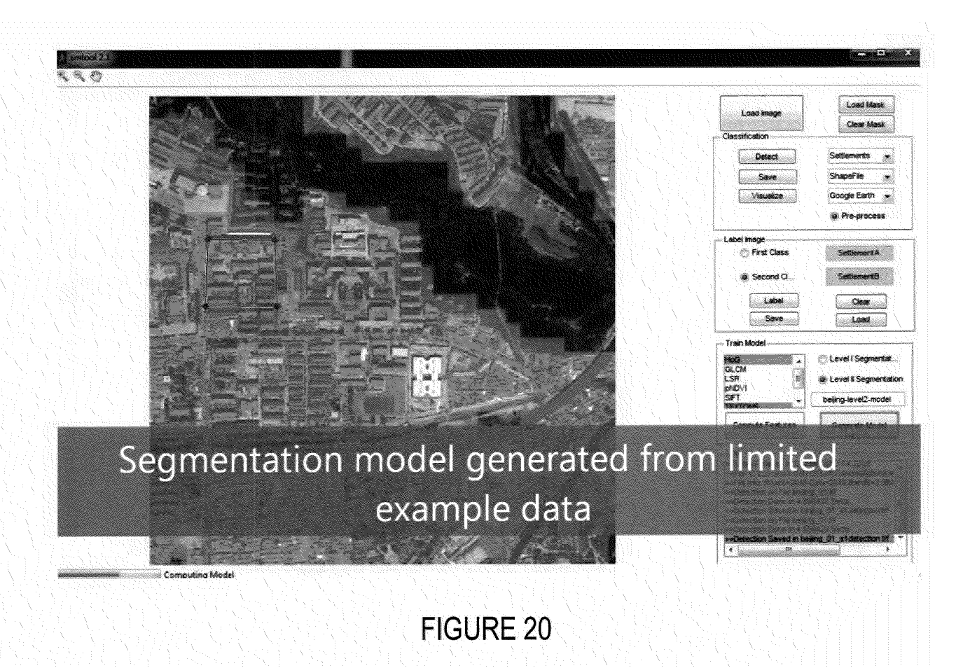

To generate a discriminative model to identify “Settlement A” and “Settlement B” region across the entire displayed image, a user provides a unique name (e.g., Beijing-level2-model in FIG. 19) for the model and activates the generate model object rendered on the display. The model learns the attributes that discriminate these classes from the limited training sample provided by the bounded areas and resolution established by the user as shown in FIG. 20. The settlement extraction system's models may include (1) Support Vector Machines (SVM) (2) Semi-Supervised Support Vector Machines and, (3) Multiview Classification. The latter two options may use unlabeled image data in model learning process.

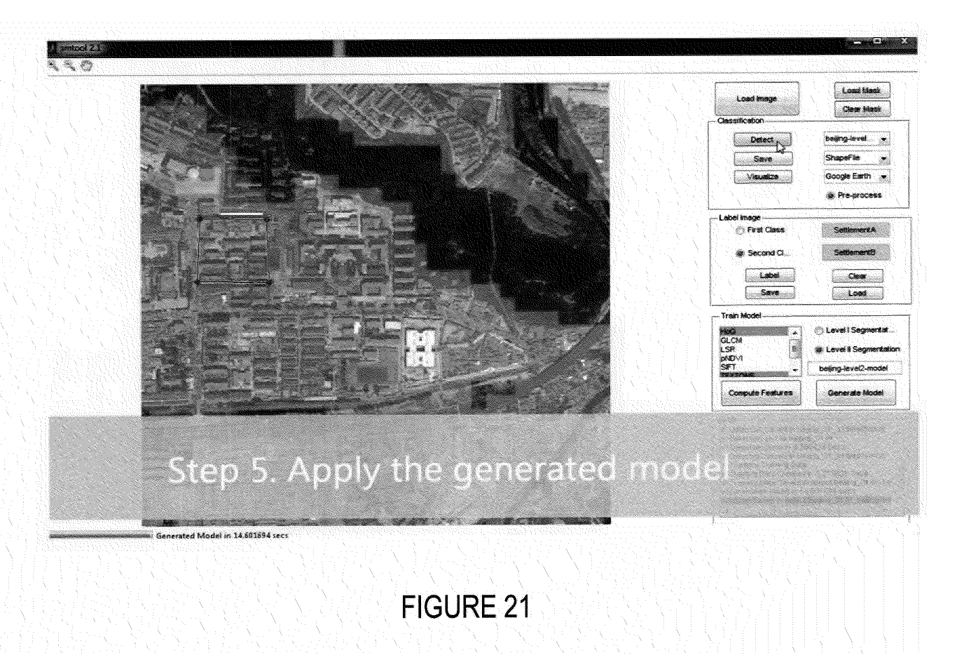

To detect the settlement classes, settlement extraction system applies the learned model on the entire image to identify “Settlement A” and “Settlement B” classes. In operation a user may select the model from a pull-down menu positioned adjacent to detect object to activate the classification engine that applies the learned attributes that discriminate the settlement classes from the limited training samples, such as the two polygonal-like portions/patches designated by the user shown in FIG. 21. In some systems the designations comprise less than about one percent, about five percent, about ten percent, or about fifteen percent of the pixels that comprise or make-up the image. The level one settlement and level two settlement detections (e.g., designated Settlement

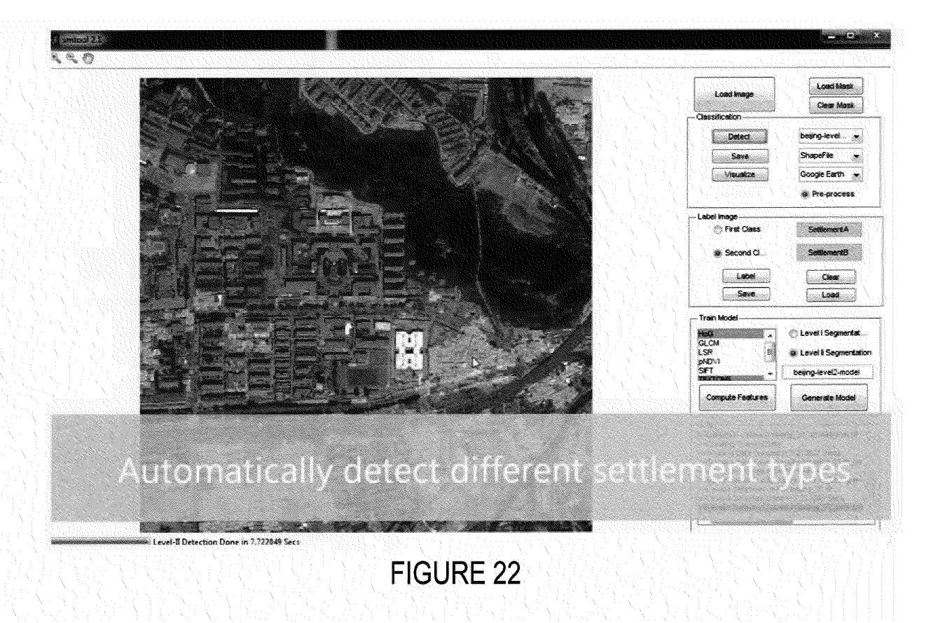

A and Settlement B) may detect, then identify and characterize an entire image into settlements and non-settlements in seconds based on spatial and structural patterns and may be color coded, highlighted, or differentiated by different intensities or animations to differentiate the classes (e.g., FIG. 22). Some settlement mapping systems may alter the appearance of settlements and non-settlements, may display the settlements in reverse video (e.g. light on dark rather than dark on light, and vice versa), and/or display them by other means that call attention to them such as through a hover message. Further, the settlement extraction system may apply any model to other images such as images from the geospatial neighborhoods and may discriminate three, four, or more classes (or settlements). And, the settlement extraction system may be a unitary part of or integrated with a machine vision system or satellite-based system used to provide image-based automatic detection and analysis. In some systems a settlement comprises a community where people live or territories that are inhabited; in other systems a settlement may comprise areas with high or low density of structures including human-created structures; in others it may comprise an area defined by a governmental office (e.g., such as by a census bureau); and in others it may comprise any combination thereof.

The methods, devices, systems, and logic described above may be implemented in many different ways in many different combinations of hardware, software or both hardware and software. For example, all or parts of the system may detect and identify settlements through one or more controllers, one or more microprocessors (CPUs), one or more signal processors (SPU), one or more graphics processors (GPUs), one or more application specific integrated circuit (ASIC), one or more programmable media or any and all combinations of such hardware. All or part of the logic described above may be implemented as instructions for execution by multi-core processors (e.g., CPUs, SPUs, and/or GPUs), controller, or other processing device including exascale computers and may be displayed through a display driver in communication with a remote or local display, or stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The settlement extraction systems may evaluate images shared and/or distributed among multiple system components, such as among multiple processors and memories (e.g., non-transient media), including multiple distributed processing systems.

Parameters, databases, mapping software, pre-generated models and data structures used to evaluate and analyze or pre-process the high and/or low resolution images may be separately stored and managed, may be incorporated into a single memory block or database, may be logically and/or physically organized in many different ways, and may be implemented in many ways, including data structures such as linked lists, hash tables, or implicit storage mechanisms. Programs may be parts (e.g., subroutines) of a single program, separate programs, application program or programs distributed across several memories and processor cores and/or processing nodes, or implemented in many different ways, such as in a library or a shared library accessed through a client server architecture across a private network or public network like the Internet. The library may store detection and classification model software code that performs any of the system processing described herein. While various embodiments have been described, it will be apparent to those of ordinary skill in the art that many more embodiments and implementations are possible.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount. When devices are responsive to commands events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of detecting settlements from satellite imagery using a computer processor that is preprogrammed comprising:
reading satellite imagery data;
designating only a portion of the satellite imagery data as a settlement;
transforming the satellite imagery data into a settlement classification or a non-settlement classification by discriminating pixels within a satellite image based on the designation of the portion of the satellite imagery data; and
altering the appearance of a visual display rendered by processing the satellite imagery data to differentiate settlements from non-settlements.

2. The method of claim 1 where the act of designating only a portion of the satellite imagery data designates less than about one percent of the pixels that comprise the satellite image.

3. The method of claim 1 where the act of designating only a portion of the satellite imagery data designates less than about five percent of the pixels that comprise the satellite image.

4. The method of claim 1 where the act of designating only a portion of the satellite imagery data comprises generating a discriminative model based on a feature analysis.

5. The method of claim 4 where the feature analysis comprises two or more of a histogram of oriented gradients, a gray level co-occurrence matrix, line support regions, a scale invariant feature transform, textrons, spectral ratios, and pseudo NDVI.

6. The method of claim 4 where the feature analysis comprises a histogram of oriented gradients, a gray level co-occurrence matrix, line support regions, a scale invariant feature transform, and textrons.

7. The method of claim 4 where the feature analysis comprises three or more of a histogram of oriented gradients, a gray level co-occurrence matrix, a scale invariant feature transform, textrons, and pseudo NDVI.

8. The method of claim 1 where the visual display comprises a visual map of the earth that highlights settlements through the superimposition if images.

9. A programmable media comprising:
a graphical processing unit in communication with a memory element;
the graphical processing unit configured to detect one or more settlement regions from a bitmapped image based on the execution of programming code; and
the graphical processing unit further configured to identify one or more settlement through the execution of the programming code that generates one or more virtual maps that alters the appearance of all of the settlement regions in the one or more virtual maps based on a partial designation of the bitmapped image.

10. The programmable media of claim 9 where the graphical processing unit is configured to execute two or more multi-scale low level feature analysis to generate a discriminatory model based on training data.

11. The programmable media of claim 9 where the graphical processing unit is further configured to:
divide the bitmapped image into pixel blocks;
compute a multiscale feature for each pixel block;
map each pixel block to a dimensional vector; and
classify each pixel block into a settlement region or a non-settlement region.

12. The programmable media of claim 11 where the division of the bitmapped image is based on a neighborhood-based analysis.

13. The programmable media of claim 11 where the neighborhood-based analysis renders pixel labels in conditional random fields.

14. The programmable media of claim 9 where the graphical processing unit is further configured to:
filter the bitmapped image;
assign words to the filter response; and
render a visual image.

15. The programmable media of claim 9 where the partial designation of the bitmapped image comprises less than about one percent of the pixels that comprise the bitmapped image.

16. The programmable media of claim 9 where the graphical processing unit is configured to generate a discriminative model based on a programmed feature analysis.

17. The programmable media of claim 16 where the feature analysis comprises two or more of a histogram of oriented gradients, a gray level co-occurrence matrix, line support regions, a scale invariant feature transform, textrons, spectral ratios, and pseudo NDVI.

18. The programmable media of claim 16 where the feature analysis comprises a histogram of oriented gradients, a gray level co-occurrence matrix, line support regions, a scale invariant feature transform, and textrons.

19. The programmable media of claim 16 where the feature analysis comprises three or more of a histogram of oriented gradients, a gray level co-occurrence matrix, a scale invariant feature transform, textrons, and pseudo NDVI.

20. The method of claim 1 where the one or more visual maps comprises a visual map of the earth that highlights settlements through the superimposition of images.
